(19) United States
(12) Patent Application Publication
(10) Pub. No.: US 2026/0233454 A1
(43) Pub. Date: Aug. 13, 2026

(54) DEVICE FOR INVERTING THE SHOULDER OF A CONTAINER HAVING AT LEAST ONE DEFORMABLE SHOULDER

(71) Applicant: SIDEL PARTICIPATIONS, Octeville-sur-Mer (FR)

(72) Inventors: Nicolas CHOMEL, OCTEVILLE- SUR-MER (FR); Jocelyn MICHEL, OCTEVILLE- SUR-MER (FR); Frédéric LECOMTE, OCTEVILLE- SUR-MER (FR)

(21) Appl. No.: 19/530,810

(22) Filed: Feb. 5, 2026

(30) Foreign Application Priority Data
Feb. 7, 2025 (FR) 2501250

(51) Int. Cl. B29C 49/42; B29L 31/00; B65D 1/02

(52) U.S. Cl. CPC B29C 49/42832; B65D 1/0223; B29L 2031/7158

(57) ABSTRACT

Provided is a device for inverting the articulation of the shoulder of a container produced from a plastics preform having a shoulder articulable between an extended position and a retracted position. The device includes at least one framework through which a conveyor conveying containers along a path between an inlet and an outlet can extend. An arm mounted on the framework can bear a belt stretched between a driving pulley, a driven pulley, and a squashing pulley extending therebetween such that the belt has an upper strand and a lower strand extending in line with the conveyor. The lower strand has a squashing segment extending between the driven pulley and the squashing pulley to form an angle of 1.5° to 5° with the horizontal, and a pressure reducing segment extending between the squashing pulley and the driving pulley to form an angle of −2° to −7° with the horizontal.

### CROSS-REFERENCE TO RELATED APPLICATIONS

This application claims the benefit of French Application No. FR2501250, filed Feb. 7th, 2026, the entire contents of which is hereby incorporated herein by reference.

### TECHNICAL FIELD

The present disclosure relates to a device for inverting the shoulder of a container having at least one deformable shoulder, such as, for example, a bottle made of polyethylene terephthalate (PET) and/or of recycled polyethylene terephthalate (rPET) that is potentially stackable, comprising, to this end, a bottom and a neck that are substantially complementary so as to allow stable stacking of the containers.

### BACKGROUND

It is well known to produce so-called stackable containers. This is the case, in particular in the American patent US 2 077 027, which describes a stackable container, which comprises a body and a frustoconical shoulder attached and fastened to the body by a folded edge. The stacking of this type of container is naturally stable, but this stability is based largely on the (metallic) material from which the container is made.

However, it is difficult to obtain such stability when the container is obtained by blow moulding (or stretch blow moulding) from a blank (in particular a preform) made of plastics material such as polyethylene terephthalate, known as PET. This is because, besides the fact that plastics materials are naturally malleable, the requirements of the market mean that production tends towards lightening of the containers, thereby reducing the rigidity of said containers.

In this regard, the document EP 0 698 557 describes a stackable container made of plastics material, the bottom of which is shaped in a manner substantially complementary with the neck in order to allow stacking. To this end, the bottom and the shoulder of the container are provided, on their periphery, with flat bearing surfaces, and the bottom is also provided with a recessed portion for receiving the neck of an underlying container.

However, the production of such a container requires, in order to produce the bottom, a substantial quantity of material, which is necessary to make the bottom sufficiently rigid, this being able to give the whole container good mechanical integrity and good stability while it is stacked. Similarly, a sufficient quantity of material is necessary for good blow mouldability of the bottom (meaning its capability of being correctly formed). On the other hand, excessive lightening of the container, in particular at its bottom, is detrimental to the mechanical integrity of the container and to the stability of its stacking.

In order to overcome these drawbacks, a container comprising means for creating a positive pressure inside the container and, ultimately, for reinforcing said container have already been conceived of. This is the case, in particular, in the document WO2007/127337.

Said document WO2007/127337 describes a plastics container having an upper part comprising a neck intended to receive a closure, a lower part comprising a base, and a side wall extending between the upper part and the lower part. The upper part, the lower part and the side wall define an internal volume intended to store liquid contents. The plastics container also has a pressure panel that is situated on the container and is movable between a starting position and an activated position. The pressure panel is situated in the starting position before the container is filled and is placed in the activated position after the container has been filled. The movement of the pressure panel from the starting position to the activated position reduces the internal volume of the container and creates a positive pressure inside the container, said positive pressure reinforcing the side wall.

Also known is the document EP2861499, from the Applicant company, which describes a container, the shoulder of which is articulated between at least one stable, so-called extended position and a stable, so-called retracted position in which the internal volume of the container is reduced so as to create a positive pressure inside the latter.

Said document EP2861499 (WO2013186463A2) describes a container obtained by blow moulding or stretch blow moulding from a plastics blank, which comprises a body, a shoulder in the continuation of the body at an upper end of the latter, and a neck in the continuation of the shoulder, the shoulder being articulated between two stable positions, namely an extended position, in which the shoulder protrudes from the body, and a retracted position, in which the shoulder is at least partially retracted into the body, the shoulder being articulated in order to be able to take up, besides the extended position and the retracted position, a third stable position, which is intermediate between the extended position and the retracted position.

The retracted position, in which stacking can be carried out, makes it possible to reduce the shoulder height and, consequently, the accommodating volume provided in the bottom. Moreover, with the shoulder being placed in its retracted position after the container has been filled and closed, the contents of said container are pressurized, thereby increasing the stiffness of said container. Thus, the stability of the stacking of containers is increased while reducing the quantity of material necessary to form the bottom.

However, it is difficult to obtain an effective compromise between the stacking stability and the lightness of a plastics container. Furthermore, it is now a requirement to increasingly reduce the weight of the containers not only for economic reasons, given the increase in the cost of the raw materials, but also for environmental reasons.

Thus, in order to improve the rigidity and the stability of the stacking of containers of which the quantity of material, and consequently its weight, is as low as possible without otherwise introducing additional pressurized gas, such as liquid nitrogen, for example, into said containers, the Applicant company filed the patent application FR3139322A1, relating to a container having a shoulder which is articulated between at least two stable positions, namely a so-called extended position, in which the shoulder protrudes from the body, and a so-called retracted position, in which the shoulder extends at the same level as the upper end of the body or is at least partially retracted into the body.

More specifically, the document FR3139322A1 describes a container obtained by blow moulding or by stretch blow moulding from a plastics blank, which comprises a body, a shoulder in the continuation of said body at an upper end of the latter, a neck in the continuation of the shoulder, said shoulder being articulated between at least two stable positions, namely a so-called extended position, in which the shoulder protrudes from the body, and a so-called retracted position, in which the shoulder extends at the same level as the upper end of the body or is at least partially retracted into the body, and a bottom at the lower end of said body. Said body is articulated at the lower end of the body between at least two stable positions, namely a so-called extended position, in which the bottom extends at the same level as the lower end of the body or protrudes at least partially from the body, and a so-called retracted position, in which said bottom is at least partially retracted into the body such that, when the container has been filled and closed, the movement of the shoulder from the extended position to the retracted position causes the bottom to move from the retracted position to the extended position, and vice versa.

In order to invert the shoulder of this type of container, i.e. to cause the shoulder to move from the extended position to the retracted position, a suitable device is necessary. In this regard, such a device is described in the document WO2018/073442A1, said device being suitable for inverting the shoulder of hot filled bottles which are usually provided with vacuum panels reinforcing the bottle and which are now provided with a peripheral groove at the shoulder, which is designed to collapse on itself, thereby causing inversion of the shoulder, when an axial compressive force is applied to the bottle.

Said document WO2018/073442A1 thus describes a hot filling device comprising a compression machine designed to apply an axial compressive force to a collapsible thermoplastic container for liquids, the compression machine comprising at least one lower body having a surface designed to be a bearing surface for the base of the container; at least one upper body designed to come into contact with a part of the container above the peripheral groove, such that the container can be kept in a vertical position by the lower body or bodies or the upper body or bodies; actuating means for actuating the lower body or bodies and/or the upper body or bodies, in order to apply said axial compressive force, acting along a direction parallel to the longitudinal axis of the container, in order to cause the proximal straight side to come into contact with the distal straight side, thereby reducing the internal volume of the container.

However, this type of device has the drawback of not allowing the inversion of the shoulder effectively at very high throughputs of around 80,000 bottles per hour. One of the aims of the disclosure is therefore to overcome all or some of these drawbacks.

### SUMMARY

To this end, the disclosure provides for a device for inverting the articulation of the shoulder of a container produced by blow moulding or by stretch blow moulding from a plastics blank, which comprises at least a body, a shoulder in the continuation of said body at an upper end of the latter, a neck in the continuation of the shoulder, said shoulder being articulated between at least two stable positions, namely a so-called extended position, in which the shoulder protrudes from the body, and a so-called retracted position, in which the shoulder extends at the same level as the upper end of the body or is at least partially retracted into the body, and a bottom at the lower end of said body; the device being noteworthy in that it comprises at least one framework through which a conveyor conveying containers along a path between an inlet and an outlet is able to extend and on which there is mounted an arm bearing a belt stretched between at least three pulleys, a driving pulley, a driven pulley and a so-called squashing pulley extending between the driving pulley and the driven pulley such that the belt has an upper strand and a lower strand which extends in line with the conveyor, said lower strand of the belt having a first, so-called squashing segment that extends between the driven pulley and the squashing pulley and forms an angle of between 1.5° and 5° with respect to the horizontal, and a second, so-called pressure reducing segment that extends between the squashing pulley and the driving pulley and forms an angle of between −2° and −7° with respect to the horizontal.

Furthermore, the squashing segment of the belt is longer than the pressure reducing segment of said belt.

Preferably, said second, so-called pressure reducing segment of the belt forms an angle of −4.5° with respect to the horizontal.

Furthermore, the first, so-called squashing segment of the belt forms, preferably, an angle of 2.5° with respect to the horizontal.

Advantageously, the device has a plurality of ball rollers that are secured to the arm and bear on the inner face of the lower strand of the belt in the first, squashing segment and/or in the second, pressure reducing segment, the axes of said ball rollers extending perpendicularly to the arm and to the direction of movement of the lower strand of the belt.

According to one design variant, the device has at least one so-called sliding plate that is secured to the arm and bears on the inner face of the lower strand of the belt in the first, squashing segment and/or in the second, pressure reducing segment.

Furthermore, the driving pulley is driven in rotation by an electric motor such that the speed of the lower strand of the belt is substantially equal to the speed of movement of the conveyor, the lower strand of the belt moving in the same direction as the conveyor.

In addition, the framework has a base and at least one vertical frame to which two vertical rails are secured, along which a carriage is able to slide, on which the arm bearing the belt is articulated.

Advantageously, the device has at least one sensor that is able to measure the height of the caps of the containers.

Said sensor is mounted at the free end of an arm secured to the carriage such that said sensor extends in line with the conveyor at the level of the outlet of the latter.

Furthermore, the device has means for adjusting the height of the carriage along the vertical frame of the framework on which the arm bearing the belt is articulated, said adjustment of the height of the carriage depending on the measurement of the height of the caps of the containers and/or of the distance from the conveyor that is carried out by said sensor.

Preferably, the device has a system for rapid retraction of the belt in the event of blockage in order to protect the conveyor.

Said retraction system consists of a pivot secured to the carriage and about which the arm bearing the belt is articulated, said pivot being positioned at the inlet of the conveyor, and a cylinder, the free ends of which are secured to the arm and to the carriage.

Advantageously, at least the outer face of the belt, i.e. the face of the belt that comes into contact with the container during the shoulder squashing phase, is coated with a layer of a material having a Shore A hardness of between 50 and 80 and, preferably, between 60 and 70. Such a coating makes it possible to increase the friction of the belt against the caps of the containers during the phase of squashing, i.e. of turning back, the shoulder of the containers, preventing the containers from dropping.

Said layer coating the belt is, preferably, low-hardness thermoplastic polyurethane TPU SM6 FDA.

### BRIEF DESCRIPTION OF THE DRAWINGS

Further advantages and features will become more clearly apparent from the following description of a number of design variants, which are given by way of non-limiting example, in accordance with the disclosure, with reference to the appended drawings, in which:

FIG. 1 is a perspective view illustrating a container, the shoulder of which has been retracted by the device according to the disclosure into a so-called retracted position of the shoulder,

FIG. 2 is an elevation view of the upper part of the container in an extended position of the shoulder,

FIG. 3 is an elevation view of the upper part of the container in a retracted position of the shoulder,

FIG. 4 is partial face-on view of the device for inverting the articulation of the shoulder of a container, according to embodiments of the present disclosure,

FIG. 5 is a perspective view of the device for inverting the articulation of the shoulder of a container, according to embodiments of the present disclosure,

FIG. 6 is a face-on view of the device for inverting the articulation of the shoulder of a container, according to embodiments of the present disclosure,

FIG. 7 is a side view of the device for inverting the articulation of the shoulder of a container, according to embodiments of the present disclosure,

FIG. 8 is a top view of the device for inverting the articulation of the shoulder of a container, according to embodiments of the present disclosure, and

FIG. 9 is a partial face-on view of the device for inverting the articulation of the shoulder of a container, according to embodiments of the present disclosure.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The following examples are put forth so as to provide those of ordinary skill in the art with a complete disclosure and description of how to perform the methods and use the devices and methods disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

The terms used herein are intended to have their ordinary meaning unless specifically defined otherwise. Directional terms such as “upper,” “lower,” “front,” “back,” and similar terms are used for convenience and are not intended to be limiting unless the context clearly indicates otherwise. The use of “may,” “can,” “could,” and similar terms indicates possible embodiments and is not intended to limit the scope of the disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

In the rest of the description, the same reference numerals denote the same elements. Furthermore, the different views are not necessarily drawn to scale.

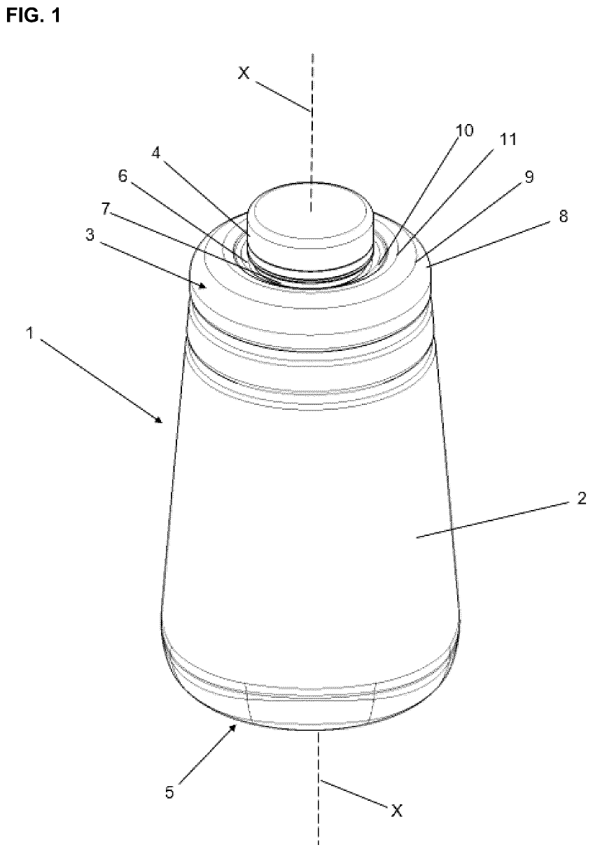

FIGS. 1 to 3 show a container 1 obtained by blow moulding, or stretch blow moulding, from a plastics blank, wherein the shoulder has been inverted by the device according to embodiments of the present disclosure, which will be described in more detail below. Said blank is, for example, a preform, but it may also be an intermediate container that has undergone a first, transitional blow moulding operation.

With reference to FIGS. 1 to 3, said container 1 comprises a body 2 of substantially frustoconical shape which extends along a main axis X, said main axis X being vertical, the container 1 being conventionally depicted in a vertical position. It will be noted that the body 2 is not necessary rotationally symmetrical about its main axis X. Specifically, it could have a circular cross section, such as a cylinder, or have a square cross section with edges with or without a quarter round shape, i.e. rounded at the corners, without otherwise departing from the scope of the invention.

Said container 1 also comprises a shoulder 3 in the continuation of the body 2 at an upper end of the latter, a neck 4 in the continuation of the shoulder 3, and a bottom 5 in the continuation of the body 2 at a lower end. Said neck 4 has, in the vicinity of its junction with the shoulder 3, a collar 6, which is already present at the open end of the blank and allows said blank to be suspended in various manufacturing steps of the container 1. Furthermore, between the collar 6 and the shoulder 3, the container 1 has an under-neck section 7, in the form of a cylinder of revolution about the main axis X, providing enough space to accommodate a member for gripping the container 1, for example a gripper.

Said shoulder 3 comprises a peripheral section 8 in the form of a relatively narrow strip of material, i.e. a strip with a width of between 0.5 and 25 mm, the width depending in particular on the dimensions of the container 1, which extends from an external edge and which defines a first, so-called external articulation 9 of the shoulder 3 with respect to the body 2, at a junction between the body 2 at the upper end of the latter as far as an internal edge concentric with the external edge, said internal edge defining a second, so-called internal articulation 10 of a central section 11 of the shoulder 3 with respect to the peripheral section 8. The central section 11 of the shoulder 3 is substantially frustoconical and extends from the internal articulation 10 of the peripheral section 8 as far as the under-neck section 7.

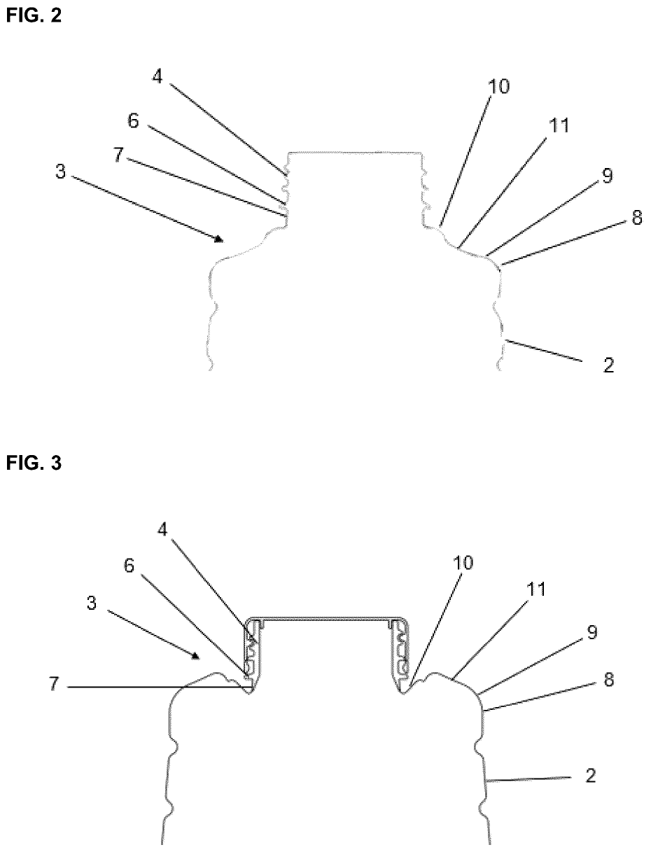

The external articulation 9 and internal articulation 10 allow the shoulder 3 to take up two stable positions, namely a so-called retracted position, shown in FIGS. 1 and 3, in which the shoulder 3 is at least partially retracted into the body 2, the shoulder being retracted towards the bottom 5, along the main axis X, and the peripheral section 8 and the central section 11 both extending in an inclined manner, meaning that their conicity points in the direction of the neck 4, i.e. upwards, and towards the main axis X; and a so-called extended position, shown in FIG. 2, in which the shoulder 3 protrudes from the body 2, the peripheral section 8 and the central section 11 both extending in an inclined manner, meaning that their conicity points in the direction of the neck 4, i.e. upwards, towards the main axis X.

It will be noted that the extended position (FIG. 2) is produced by moulding, meaning that it is in this extended position that the container 1 is moulded. It is also in this extended position that the container 1 is filled and capped.

The movement of the shoulder 3 from the extended position, in which the container is filled and then capped by a cap, to the retracted position is effected by turning back the central section 11 about the internal articulation 10 of the shoulder 3 by exerting a downward pressure on the cap closing the neck 4. The orientation of the peripheral section 8 remains substantially unchanged and the neck 4 is made to move in downward translation along the main axis X of the container 1, this being allowed by the central section 11 pivoting with respect to the neck 4 about the external articulation 9. Since the container 1 has been filled, the retraction of the shoulder 3 pressurizes the contents of the container 1. Furthermore, in this particular exemplary embodiment, in the retracted position of the shoulder 3, the height of the container 1 is less than the height of said container 1 when the shoulder 3 is in the extended position.

In order to exert this downward pressure on the cap closing the neck 4 in order to turn back the central section 11 about the internal articulation 10 of the shoulder 3, i.e. to invert the shoulder 3, a device 100 for inverting said articulation of the shoulder according to the present disclosure is used.

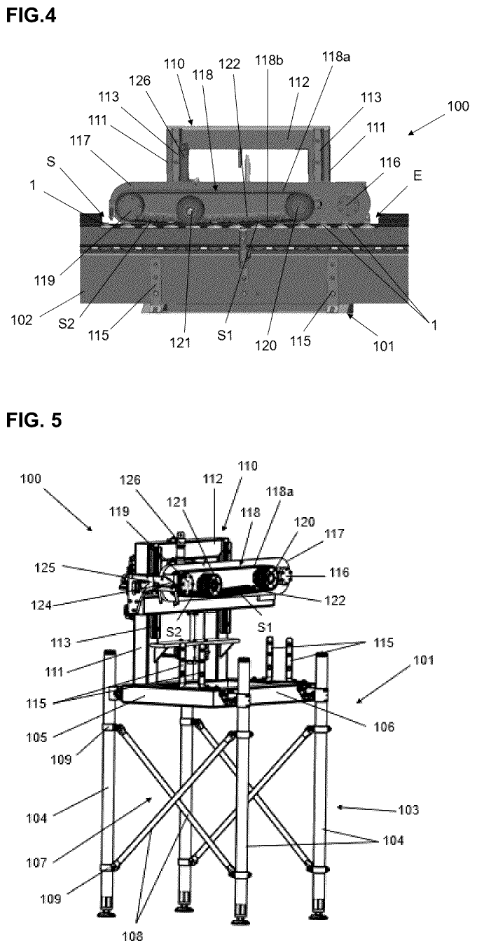

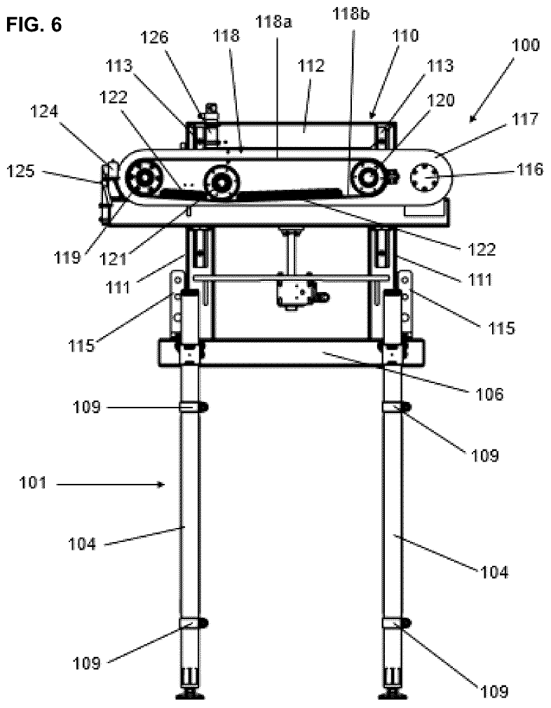

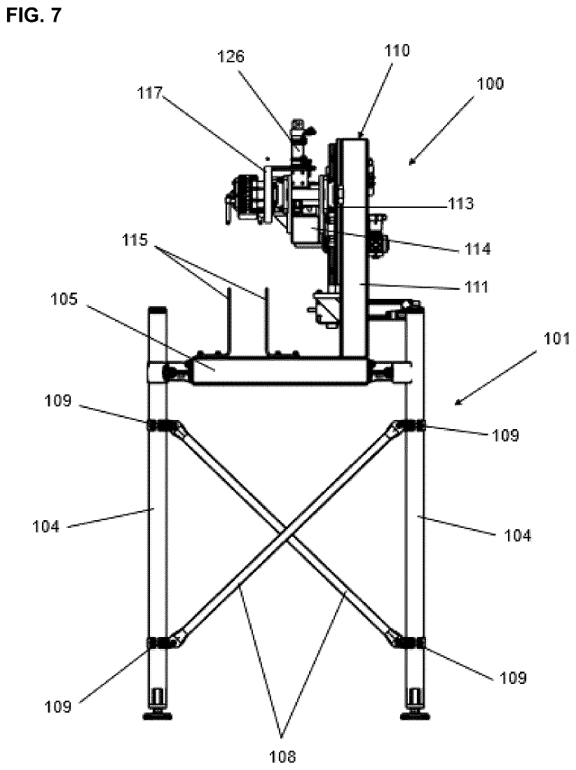

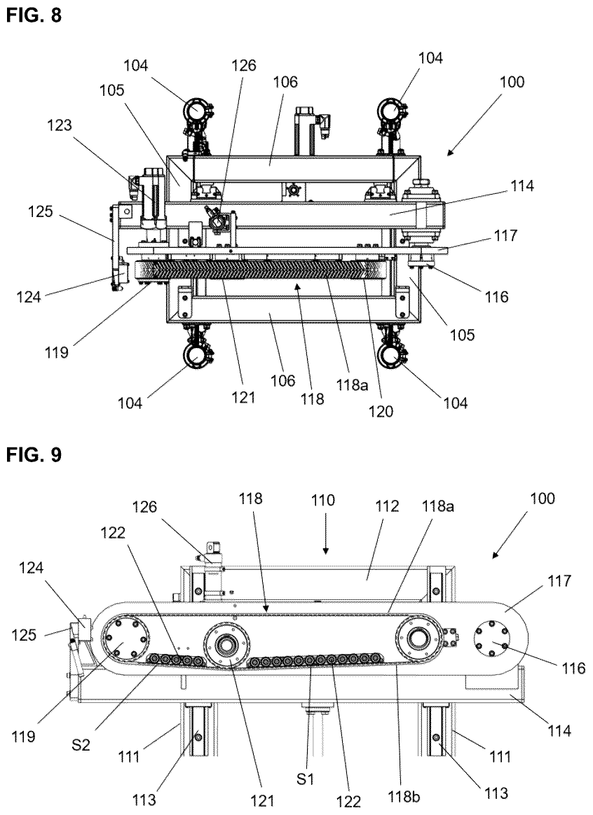

Said device 100 for inverting the articulation of the shoulder of the container, with reference to FIGS. 4 to 9, comprises at least one framework 101 through which a conveyor 102 conveying containers 1, as described above, is able to extend along a path from an inlet (E) to an outlet(S).

Said framework 101 is made up of a base 103 comprising four tubular legs 104 that are connected, close to their upper end, by two cross members 105 and two longitudinal members 106, each pair of legs 104 being reinforced by cross-braces 107 made up of metal bars 108 that are provided at their free ends with clamping flanges 109 engaged with the tubular legs 104. Furthermore, said framework 101 has a vertical frame 110 made up of two uprights 111 that extend from a longitudinal member 106 of the base 101, the upper ends of said uprights 111 being connected by an upper longitudinal member 112. Secured to the uprights 111 of the vertical frame 110 are two vertical rails 113, along which a carriage 114 is able to slide.

In order to allow the conveyor 102, preferably a belt conveyor, to be secured to said framework 101, each cross member 105 of the base 101 has a pair of vertical tabs 115, the spacing between the tabs 115 of each pair corresponding to the width of said conveyor 102.

It is clear that the belt conveyor 102 could be replaced by any other type of conveyor that is well known to a person skilled in the art, without otherwise departing from the scope of the invention.

Furthermore, mounted on said carriage 114, about a pivot 116, said pivot extending in line with the inlet (E), is an arm 117 bearing a belt 118 stretched between three pulleys, a driving pulley 119, a driven pulley 120 and a so-called squashing pulley 121 extending between the driving pulley 119 and the driven pulley 120 such that the belt 118 has an upper strand 118a and a lower strand 118b which extends in line with said conveyor 102, which extends substantially horizontally.

Said lower strand 118b of the belt has a first, so-called squashing segment S1, which extends between the driven pulley 120 and the squashing pulley 121, forming an angle of between 1.5° and 5° with respect to the horizontal, and a second, so-called pressure reducing segment S2, which extends between the squashing pulley 121 and the driving pulley 119, forming an angle of between −2° and −7° with respect to the horizontal.

In this particular exemplary embodiment, said first, so-called squashing segment S1 of the belt 118 forms, preferably, an angle of 2.5° with respect to the horizontal and the second, so-called pressure reducing segment S2 of the belt 118 forms, preferably, an angle of −4.5° with respect to the horizontal.

Advantageously, said device according to the invention has a plurality of ball rollers 122 that are secured to the arm 117 and bear on the inner face of the lower strand 118b of the belt 118 in the first, squashing segment S1 and/or in the second, pressure reducing segment S2, the axes of said ball rollers 122 extending perpendicularly to the arm 117 and to the direction of movement of the lower strand 118b of the belt 118.

According to one design variant, which is not shown in the figures, the plurality of ball rollers 122 that are secured to the arm 117 and bear on the inner face of the lower strand 118b of the belt 118 in the first, squashing segment S1 and/or in the second, pressure reducing segment S2 could be replaced by a so-called sliding plate that is secured to the arm 117 and bears on the inner face of the lower strand 118b of the belt 118.

Furthermore, the driving pulley 119 is driven in rotation by an electric motor 123 secured to the arm 117 such that the speed of the lower strand 118b of the belt 118 is substantially equal to the speed of movement of the belt conveyor 102, the lower strand 118b of the belt 118 moving in the same direction as the conveyor 102. In this regard, means for synchronizing the speed of the lower strand 118b of the belt 118 with the speed of the conveyor 102 could be provided in order to adapt the speed of the lower strand 118b of the belt 118 to that of the conveyor in the event of variation in the throughput, the speed of the conveyor 102 being able to be reduced or increased during said change in throughput.

Advantageously, the device has at least one sensor 124 that is able to measure the height of the caps of the containers 1 travelling on the conveyor 102 and/or to measure the distance from the conveyor 102. Said sensor 124 is, for example, secured to a bracket 125 that is secured to the carriage 114 and extends downstream of the arm 117, i.e. in line with the outlet(S) of the conveyor 102. Said sensor 124 could consist of any distance measuring sensor that is well known to a person skilled in the art.

Furthermore, the device advantageously has means for adjusting the height of the carriage 114 along the vertical frame 110 of the framework 101 on which the arm 117 bearing the belt 118 is articulated, said adjustment of the height of the carriage 114 depending on the measurement of the height of the caps of the containers 1 carried out by said sensor 124 and/or on the measurement of the distance from the conveyor 102.

In addition, advantageously, the device also has a system for rapid retraction of the belt 118 in the event of blockage in order to protect the conveyor 102 in particular.

Said retraction system consists of the pivot 116 which is secured to the carriage 114 and about which the arm 117 bearing the belt 118 is articulated, said pivot 116 being positioned at the inlet (E) of the conveyor 102, and a cylinder 126, the free ends of which are secured to the arm 117 and to the carriage 114.

Furthermore, advantageously, at least the outer face of the belt 118, i.e. the face of the belt 118 that comes into contact with the containers 1 and more precisely into contact with the caps of the containers 1 during the phase of squashing the shoulder, is coated with a layer of material having a Shore A hardness of between 50 and 80 and, preferably, between 60 and 70. Such a coating makes it possible to increase the friction of the belt 118 on the caps of the containers 1 during the phase of squashing, i.e. turning back, the shoulder of the containers 1, which, combined with the gentle gradient of the squashing section (S1), creates a real hold on the containers during squashing and, ultimately, helps to prevent the containers from dropping.

It is clear that said coating layer of the belt 118 could cover all the faces of said belt without otherwise departing from the scope of the invention.

Said layer coating the belt 118 is, preferably, low hardness thermoplastic polyurethane TPU SM6 FDA with a thickness of around 3 mm.

However, it goes without saying that said material could consist of any other material having a Shore A hardness of between 50 and 80, such as rubber, for example, and that the coating layer could have any thickness without otherwise departing from the scope of the invention.

It will be clearly understood that, with the containers 1 transported on the conveyor 102 being in an extended position, said containers 1 also having been filled and capped, said containers arrive at the inlet (E) of the conveyor such that the first, so-called squashing segment S1 of the lower strand 118b of the belt 118 which extends between the driven pulley 120 and the squashing pulley 121, forming an angle of between −2° and −7° with respect to the horizontal, brings about a compressive force which turns back the central section 11 about the internal articulation 10 of the shoulder 3 of the container 1 by exerting a downward pressure on the cap closing the neck 4, thereby inverting the shoulder 3 of the container 1. The orientation of the peripheral section 8 remains substantially unchanged and the neck 4 is made to move in downward translation along the main axis of the container 1, this being allowed by the central section 11 pivoting with respect to the neck 4 about the external articulation 9. Since the container 1 has been filled, the retraction of the shoulder 3 pressurizes the contents of the container 1.

At the outlet of the squashing segment S1, the shoulder 3 of the containers 1 is in its retracted position and the height of the container 1 is less than the height of said container 1 when the shoulder 3 is in its extended position. However, since the liquid contained in the containers is then pressurized, said pressure of the liquid tends to force the shoulder to return into its extended starting position. The pressure reducing section S2, on account of the gentle and inverted gradient of the lower strand 118b of the belt 118, makes it possible to reduce the pressure of the liquid contained in the containers while preventing the shoulder 3 of the containers 1 from returning into its extended position, or falling, such that, at the outlet S of the conveyor 102, the shoulder 3 of the containers 1 is in its retracted vertical position.

Lastly, it is clear that the examples that have just been given are only particular illustrations that are in no way limiting in relation to the fields of application of the invention. Therefore, at least the following is claimed:

1. A device for inverting an articulation of a shoulder of a container, the device comprising:
at least one framework through which a conveyor conveying containers along a path between an inlet and an outlet is configured to extend and on which there is mounted an arm bearing a belt stretched between at least three pulleys,
the pulleys comprising a driving pulley, a driven pulley, and a squashing pulley extending between the driving pulley and the driven pulley such that the belt has an upper strand and a lower strand which extends in line with the conveyor,
said lower strand comprising a squashing segment that extends between the driven pulley and the squashing pulley and forms an angle of between 1.5° and 5° with respect to a horizontal plane, and
a pressure reducing segment that extends between the squashing pulley and the driving pulley and forms an angle of between −2° and −7° with respect to the horizontal plane.

2. The device according to claim 1, wherein the squashing segment of the belt is longer than the pressure reducing segment of said belt.

3. The device according to claim 1, wherein the pressure reducing segment of the belt forms an angle of −4.5° with respect to the horizontal plane.

4. The device according to claim 1, wherein the squashing segment of the belt forms an angle of 2.5° with respect to the horizontal.

5. The device according to claim 1, wherein the device comprises a plurality of ball rollers that are secured to the arm and bear on an inner face of the lower strand of the belt in the squashing segment and/or in the pressure reducing segment, axes of said ball rollers extending perpendicularly to the arm and to a direction of movement of the lower strand of the belt.

6. The device according to claim 1, wherein he device comprises at least one sliding plate that is secured to the arm and bears on an inner face of the lower strand of the belt in the squashing segment and/or in the pressure reducing segment.

7. The device according to claim 1, wherein the driving pulley is driven in rotation by an electric motor such that a speed of the lower strand of the belt is substantially equal to a speed of movement of the conveyor, the lower strand of the belt moving in the same direction as the conveyor.

8. The device according to claim 1, wherein the framework has a base and at least one vertical frame to which two vertical rails are secured, along which vertical rails a carriage is configured to slide, and wherein the arm bearing the belt is mounted on the carriage.

9. The device according to claim 8, wherein the device comprises at least one sensor that is configured to measure a height of caps of the containers and/or a distance from the conveyor.

10. The device according to claim 9, wherein said sensor is mounted at a free end of a bracket secured to the carriage such that said sensor extends in line with the conveyor at a level of the outlet.

11. The device according to claim 9, wherein a height of the carriage is adjustable along the vertical frame of the framework on which the arm bearing the belt is articulated, wherein an adjustment of the height of the carriage depends on a measurement of the height of the caps of the containers that is carried out by said sensor and/or on the distance from the conveyor.

12. The device according to claim 1, wherein the device comprises a system for rapid retraction of the belt in an event of blockage in order to protect the conveyor.

13. The device according to claim 12, wherein said retraction system comprises a pivot secured to a carriage and about which the arm bearing the belt is articulated, said pivot being positioned at the inlet of the conveyor, and a cylinder, the free ends of which are secured to the arm and to the carriage.

14. The device according to claim 1, wherein at least an outer face of the belt is coated with a layer of a material having a Shore A hardness of between 50 and 80.

15. The device according to claim 14, wherein said layer coating the belt is low-hardness thermoplastic polyurethane TPU SM6 FDA.

16. A method of inverting a container shoulder, the method comprising:
providing a filled and capped container to a device,
wherein the device comprises at least one framework through which a conveyor conveying containers along a path between an inlet and an outlet is configured to extend and on which there is mounted an arm bearing a belt stretched between at least three pulleys, the pulleys comprising a driving pulley, a driven pulley, and a squashing pulley extending between the driving pulley and the driven pulley such that the belt has an upper strand and a lower strand which extends in line with the conveyor, said lower strand comprising a squashing segment that extends between the driven pulley and the squashing pulley and forms an angle of between 1.5° and 5° with respect to a horizontal plane, and a pressure reducing segment that extends between the squashing pulley and the driving pulley and forms an angle of between −2° and −7° with respect to the horizontal plane,
wherein the container comprises a body of substantially frustoconical shape which extends along a main axis X, a shoulder at an upper end of the body, the shoulder continuing into a neck, and a bottom, the shoulder being articulated between at least two stable positions: an extended position in which the shoulder protrudes from the body, and a retracted position in which the shoulder is at least partially retracted into the body or extends at a same level as an upper end of the body; transporting the container in the extended position on the conveyor to the inlet; and
compressing the container, by exerting a downward pressure on the cap with the squashing segment, such that a central section of the shoulder is turned about an internal articulation of the shoulder, thereby inverting the shoulder.

17. The method according to claim 16, wherein an orientation of a peripheral section of the shoulder remains substantially unchanged, and wherein the central section pivots with respect to the neck about the external articulation such that the neck is made to move in downward translation along the main axis of the container.

18. The method according to claim 17, wherein at an outlet of the squashing segment, the shoulder of the container is in the retracted position and the height of the container is less than the height of said container when the shoulder is in the extended position prior to compression and wherein contents of the container are pressurized.

19. The method according to claim 18, further comprising transporting the container along the lower strand to the outlet of the conveyor, wherein at the outlet of the conveyor a pressure of the contents of the container has been reduced such that the container remains in a vertical position and the shoulder remains in the retracted position upon exiting the outlet.
